(19) United States
(12) Patent Application Publication
(10) Pub. No.: US 2026/0253506 A1
(43) Pub. Date: Aug. 27, 2026

(54) STATE ESTIMATION APPARATUS, QUESTION RECOMMENDATION APPARATUS, STATE ESTIMATION METHOD, QUESTION RECOMMENDATION METHOD, AND PROGRAM

(71) Applicant: NTT, Inc., Tokyo (JP)

(72) Inventors: Takashi HATTORI, Tokyo (JP); Hiroshi SAWADA, Tokyo (JP); Koji KAMEI, Tokyo (JP); Futoshi NAYA, Tokyo (JP)

(73) Assignees: NIPPON TELEGRAPH AND TELEPHONE CORPORATION, Tokyo (JP); NTT, Inc., Tokyo (JP)

(21) Appl. No.: 18/877,407

(22) PCT Filed: Jun. 29, 2022
(86) PCT No.: PCT/JP2022/025899

§ 371 Date: Dec. 20, 2024

(51) Int. Cl. G09B 7/00; G06N 3/0455

(52) U.S. Cl. CPC G09B 7/00; G06N 3/0455

(57) ABSTRACT

Provided is a technique for recommending a question suitable for use in future study to a learner. Included are a correct answer rate prediction unit that estimates a predicted correct answer rate of a question by using a learned neural network from an input vector obtained from a test result of a learner of K questions or by using a decoder of a learned neural network from a latent variable vector obtained from an input vector obtained from the test result of the learner of the K questions, and a question selection unit that selects a question to be recommended to the learner from among selection candidate questions by using a reference predicted correct answer rate that is a predicted correct answer rate to be a reference for recommending a question to be solved and predicted correct answer rates of the selection candidate questions among the K questions.

### TECHNICAL FIELD

The present invention relates to a technique for recommending a learner a question suitable for use in future study.

### BACKGROUND ART

Various methods have been proposed as a method for analyzing a large amount of high-dimensional data. As one of such methods, there is a method using a variational autoencoder (VAE) described in Non Patent Literature 1. Here, the variational autoencoder is a neural network including an encoder and a decoder, the encoder is a neural network that converts an input vector into a latent variable vector, and the decoder is a neural network that converts the latent variable vector into an output vector. In addition, a latent variable vector is a vector having latent variables as its elements, and is a lower-dimensional vector than the input vector and the output vector. When an encoder of a variational autoencoder learned so that an input vector and an output vector are substantially the same is used, high-dimensional analysis target data can be converted and compressed into low-dimensional secondary data. Here, learning so as to be substantially the same is performed in a form of terminating processing assuming that the input vector and the output vector are the same when a predetermined condition is satisfied because in reality, learning has to be performed so as to be substantially the same due to a restriction of a learning time or the like although learning is preferably performed so as to be completely the same.

Non Patent Literature 1 discloses that when a variational autoencoder is learned to have monotonicity, a latent variable represents ability in a category such as “basic academic ability related to mathematics and Japanese”, “ability to manipulate words”, or “ability related to illustrations”, and a test result can be easily analyzed.

### CITATION LIST

### Non Patent Literature

Non Patent Literature 1: Takashi Hattori, Hiroshi Sawada, Takako Tonooka, Takeshi Sakata, Sanae Fujita, Tessei Kobayashi, Koji Kamei, Futoshi Naya, “Feature Extraction of Students and Problems via Exam Result Analysis using Variational Autoencoder”, The 34th Annual Conference of the Japanese Society for Artificial Intelligence, 3M1-GS-12-03, 2020.

### SUMMARY OF INVENTION

### Technical Problem

According to the method of Non Patent Literature 1, it is possible to obtain knowledge regarding the academic ability of a learner, such as having the “basic academic ability related to mathematics and Japanese” but being weak in the “ability to manipulate words”, for example. However, the method of Non Patent Literature 1 is for analyzing the test result, and does not suggest what kind of question the learner should use to advance his/her study in the future to improve his/her weak point. That is, the method of Non Patent Literature 1 cannot recommend a question suitable for use in future study to a learner.

Therefore, an object of the present invention is to provide a technique for recommending a question suitable for use in future study to a learner.

### Solution to Problem

One aspect of the present invention includes: setting input information as information indicating one of a positive state, a negative state, or an unknown state, setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state, setting p(x) as a probability that the input information x is information indicating the positive state, setting an output vector as a vector having probabilities p(x₁), . . . , p(x_{K}) for the K pieces of input information x₁, . . . , x_{K} as elements, a recording unit configured to record a parameter of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state; an encoder unit configured to calculate an estimation target latent variable vector from an estimation target input vector obtained from the K pieces of input information x₁, . . . , x_{K}, using an encoder of the learned neural network; a decoder unit configured to calculate an estimation target output vector from the estimation target latent variable vector, using a decoder of the learned neural network; and a state estimation unit configured to obtain a probability p(xₖ) corresponding to input information x_{K} (where k satisfies 1≤k≤K) indicating the unknown state from the estimation target output vector as an estimated probability that the input information x_{K} is in the positive state.

One aspect of the present invention includes: setting input information as information indicating one of a positive state, a negative state, or an unknown state, setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state, setting p(x) as a probability that the input information x is information indicating the positive state, setting an output vector as a vector having probabilities p(x₁), . . . , p(x_{K}) for the K pieces of input information x₁, . . . , x_{K} as elements, a recording unit configured to record a parameter of a decoder of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state; a decoder unit configured to calculate an estimation target output vector from an estimation target latent variable vector corresponding to an estimation target input vector obtained from the K pieces of input information x₁, . . . , x_{K}, using the decoder of the learned neural network; and a state estimation unit configured to obtain a probability p(x_{K}) corresponding to input information x_{K} (where k satisfies 1≤k≤K) indicating the unknown state from the estimation target output vector as an estimated probability that the input information x_{K} is in the positive state.

One aspect of the present invention includes: setting input information as information indicating one of a positive state, a negative state, or an unknown state, setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state, setting p(x) as a probability that the input information x is information indicating the positive state, setting an output vector as a vector having probabilities p(x₁), . . . , p(x_{K}) for the K pieces of input information x₁, . . . , x_{K} as elements, a recording unit configured to record a parameter of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state; setting the K pieces of input information as test results of K questions, and setting the positive state, the negative state, and the unknown state as a correct answer, a wrong answer, and no answer, respectively, a correct answer rate prediction unit configured to calculate an output vector from an input vector obtained from test results x_{K} (k=1, . . . , K) of a learner of the K questions by using the learned neural network, select a probability corresponding to a question of a selection candidate for a question to be recommended to the learner from elements p(xₖ) (k=1, . . . , K) of the output vector, and obtain the probability as a predicted correct answer rate of the question of the selection candidate for the question to be recommended to the learner; and setting p_{i_1}, . . . , p_{i_M} (where M is an integer of 1 or more and K or less, iₘ (m=1, . . . , M) satisfies 1≤iₘ≤K, and iₘ and i_{m′} (m≠m′) are different from each other) as predicted correct answer rates of the questions i₁, . . . , i_{M} that are the selection candidates for the question to be recommended to the learner among the K questions, and setting a reference predicted correct answer rate as a predicted correct answer rate that is reference for recommending a question to be solved, a question selection unit configured to select questions i_{m_1}, . . . , i_{m_N} to be recommended to the learner from among the questions i₁, . . . , i_{M} by using the reference predicted correct answer rate and the predicted correct answer rates p_{i_1}, . . . . P_{i_M} of the questions i₁, . . . , i_{M} that are the selection candidates for the question to be recommended to the learner among the K questions.

One aspect of the present invention includes: setting input information as information indicating one of a positive state, a negative state, or an unknown state, setting an input vector as a vector obtained from K pieces (K is an integer of 2 or more) of the input information x₁/x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state, setting p(x) as a probability that the input information x is information indicating the positive state, setting an output vector as a vector having probabilities p(x₁), . . . , p(x_{K}) for the K pieces of input information x₁, x_{K} as elements, a recording unit configured to record a parameter of a decoder of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state; setting the K pieces of input information as test results of K questions, and setting the positive state, the negative state, and the unknown state as a correct answer, a wrong answer, and no answer, respectively, a correct answer rate prediction unit configured to calculate an output vector from a latent variable vector corresponding to an input vector obtained from test results x_{K} (k=1, . . . , K) of a learner of the K questions by using the decoder of the learned neural network, select a probability corresponding to a question of a selection candidate for a question to be recommended to the learner from elements p(xₖ) (k=1, . . . , K) of the output vector, and obtain the probability as a predicted correct answer rate of the question of the selection candidate for the question to be recommended to the learner; and setting p_{i_1}, p_{i_M} (where M is an integer of 1 or more and K or less, iₘ (m=1, . . . , M) satisfies 1≤iₘ≤K, and iₘ and iₘ′ (m≠m′) are different from each other) as predicted correct answer rates of the questions i₁, . . . , i_{M} that are the selection candidates for the question to be recommended to the learner among the K questions, and setting a reference predicted correct answer rate as a predicted correct answer rate that is reference for recommending a question to be solved, a question selection unit configured to select questions i_{m_1}, . . . , i_{m_N} to be recommended to the learner from among the questions i₁, . . . , i_{M} by using the reference predicted correct answer rate and the predicted correct answer rates p_{i_1}, . . . , P_{i_M} of the questions i₁, . . . , i_{M} that are the selection candidates for the question to be recommended to the learner among the K questions.

### Advantageous Effects of Invention

According to the present invention, it is possible to recommend a question suitable for use in future study to a learner.

### BRIEF DESCRIPTION OF DRAWINGS

FIG. 1 is a diagram illustrating an example of an input vector representing a test result of a learner.

FIG. 2 is a block diagram illustrating a configuration of a neural network learning apparatus 100.

FIG. 3 is a flowchart illustrating an operation of the neural network learning apparatus 100.

FIG. 4 is a block diagram illustrating a configuration of a state estimation apparatus 200.

FIG. 5 is a flowchart illustrating an operation of the state estimation apparatus 200.

FIG. 6 is a block diagram illustrating a configuration of a state estimation apparatus 201.

FIG. 7 is a flowchart illustrating an operation of the state estimation apparatus 201.

FIG. 8 is a block diagram illustrating a configuration of a question recommendation apparatus 300.

FIG. 9 is a flowchart illustrating an operation of the question recommendation apparatus 300.

FIG. 10 is a diagram illustrating an example functional configuration of a computer that implements each device according to an embodiment of the present invention.

### DESCRIPTION OF EMBODIMENTS

Hereinafter, an embodiment of the present invention will be described in detail. Note that components having the same functions are denoted by the same reference numerals, and redundant description will be omitted.

Prior to description of embodiments, a notation method in the present specification will be described.

\hat{ } (caret) represents a superscript. For example, xy\hat{ }^{z} represents that y^{z} is a superscript for x, and x_{y\hat{ }z} represents that y^{z} is a subscript for x. Furthermore, _ (underscore) represents a subscript. For example, x^{y_z} represents that y^{z} is a superscript for x, and X_{y_z} represents that y^{z} is a subscript for x.

Further, a superscript “\hat{ }” or “~” as in \hat{ }x or ~x for a certain character x would normally be written directly above the “x”, but is written herein as \hat{ }x or ~x due to restrictions of notation in the description.

### TECHNICAL BACKGROUND

Here, a method of learning a neural network used in the embodiments of the present invention will be described. A neural network in the embodiments of the present invention is a neural network including an encoder that calculates a latent variable vector from an input vector and a decoder that calculates an output vector from the latent variable vector.

Hereinafter, the input vector, the encoder, the output vector, and a loss function according to the embodiments of the present invention will be described.

### (1: Input Vector)

In the embodiments of the present invention, the input vector is a vector representing a plurality of pieces of input information. Here, the input information is information indicating any of a positive state, a negative state, or an unknown state. Hereinafter, examples of the input vector and the input information will be described. In the above example of analysis of test results, there may be generally three types of test results of each question of a learner: correct answer, wrong answer, and no answer. Here, the “no answer” is a case where an answer to a question does not exist because the learner has not taken an examination such as a case where the learner has taken tests of Japanese and mathematics but has not taken tests of science and social studies. Therefore, in the example of analysis of test results, it is possible to express the test results of the plurality of questions of the learner as the input vector by expressing the test results of the respective questions of the learner as the input information where the correct answer, the wrong answer, and the no answer respectively correspond to a positive state, a negative state, and an unknown state. Further, another example includes analysis of information acquired by a plurality of sensors. When a sensor that detects the presence or absence of a predetermined situation is used, two types of information can be acquired: information indicating that the situation has been detected (that is, detection); and information indicating that the situation has not been detected (that is, non-detection). However, in a case where information acquired by a plurality of sensors is collected and analyzed via a communication network, information indicating that a predetermined situation has been detected or information indicating that no predetermined situation has been detected for any of the sensors may not be obtained due to loss of a communication packet or the like, and any information may not be obtained (that is, unknown situation). Therefore, in this example, it is possible to express detection results of the plurality of sensors as the input vector by expressing the detection results as the input information of the respective sensors where the detection, non-detection, and situation unknown respectively correspond to the positive state, the negative state, and the unknown state.

Then, the input vector has features as follows. [Feature 1] The input vector is a vector including a positive information bit group and a negative information bit group.

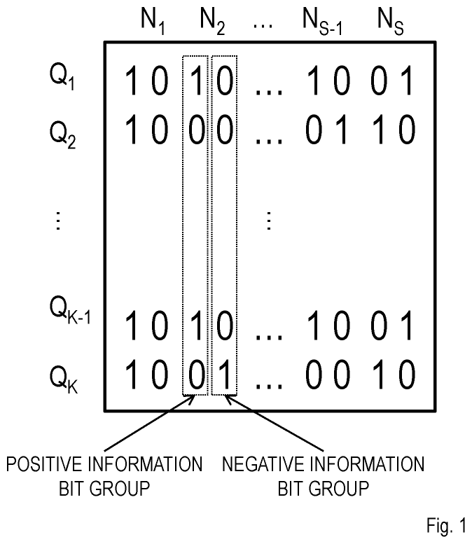

Hereinafter, description will be given using the example of analysis of test results. It is assumed that the test result of the learner is represented by using two bits of a positive information bit in which the correct answer is 1 and the no answer or the wrong answer is 0 and a negative information bit in which the wrong answer is 1 and the no answer or the correct answer is 0. In this way, x⁽¹⁾ₛₖ and x⁽⁰⁾ₛₖ are set as the positive information bit and the negative information bit for the test result of a k-th question of an s-th learner, respectively, and the input vector representing the test results of K questions of the s-th learner is a vector including the positive information bit group {x⁽¹⁾ₛ₁, x⁽¹⁾ₛ₂, . . . , x⁽¹⁾ₛₖ} and the negative information bit group {x⁽⁰⁾ₛ₁, x⁽⁰⁾ₛ₂, . . . , x⁽⁰⁾ₛₖ}. FIG. 1 illustrates an example of the input vector representing the test result of the learner. Here, Q₁, . . . , and Q_{K} in FIG. 1 represent the first question, . . . , and the K-th question, N₁ . . . , and N_{S} represent the first learner, . . . , and the S-th learner, a row represent a list of pairs of the positive information bit and the negative information bit of all the learners for each question, and a column represent a list of the positive information bit groups and the negative information bit groups for all the questions of each learner. For example, the input vector of the second learner is a vector including the positive information bit group {1, 0, . . . 1, 0} and the negative information bit group {0, 0, . . . , 0, 1}. Further, the test result of the second question of the second learner is no answer since both the positive information bit and the negative information bit are 0.

### (2: Encoder)

The encoder in the embodiments of the present invention has the following feature.

[Feature 2] A first layer (that is, a layer to which the input vector is input) of the encoder is assumed to be a layer in which intermediate information is obtained from the positive information bit group and the negative information bit group included in the input vector, the intermediate information preventing an element of the input vector corresponding to the input information indicating the unknown state from affecting the output of the encoder.

Hereinafter, description will be given using the example of analysis of test results. {qₛ₁, qₛ₂, . . . , q_{sH}} is set as an intermediate information group of the s-th learner, which is the output of the first layer of the encoder, and intermediate information qₛₕ is obtained by the following equation.

$$\begin{matrix}[ Math . 1 ] & \\ {q}_{sh} = {\sum }_{k = 1}^{K} {w}_{hk}^{( 1 )} {x}_{sk}^{( 1 )} + {\sum }_{k = 1}^{K} {w}_{hk}^{( 0 )} {x}_{sk}^{( 0 )} + {b}_{h} & ( 1 )\end{matrix}$$

Note that w⁽¹⁾ₕₖ and w⁽⁰⁾ₕₖ are a weight parameter for the h-th intermediate information with respect to the positive information bit x⁽¹⁾ₛₖ and a weight parameter for the h-th intermediate information with respect to the negative information bit x⁽⁰⁾ₛₖ, respectively, and bn is a bias parameter for the h-th intermediate information.

In a case where the test result of the k-th question of the s-th learner is the correct answer, x⁽¹⁾ₛₖ=1 and x⁽⁰⁾ₛₖ=0 are obtained. Therefore, only w⁽¹⁾ₕₖ out of the two weight parameters w⁽¹⁾ₕₖ and w⁽⁰⁾ₕₖ reacts, and w⁽⁰⁾ₕₖ does not react. Furthermore, in a case where the test result of the k-th question of the s-th learner is the wrong answer, x⁽¹⁾ₛₖ=0 and x⁽⁰⁾ₛₖ=1 are obtained. Therefore, only w⁽⁰⁾ₕₖ out of the two weight parameters w⁽¹⁾ₕₖ and w⁽⁰⁾ₕₖ reacts, and w⁽¹⁾ₕₖ does not react. Moreover, in a case where the test result of the k-th question of the s-th learner is the no answer, x⁽¹⁾ₛₖ=0 and x⁽⁰⁾ₛₖ=0 are obtained. Therefore, both the two weight parameters w⁽¹⁾ₕₖ and w⁽⁰⁾ₕₖ do not react. Note that reacting means that the weight parameter is updated at the time of learning and the weight parameter affects at the time of using the learned encoder, and non-reacting means that the weight parameter is not updated at the time of learning and the weight parameter does not affect at the time of using the learned encoder. Therefore, by using the equation (1), it is possible to obtain the intermediate information that affects the output of the encoder in the case where the input information is either information indicating the correct answer or information indicating the wrong answer, but does not affect the output of the encoder in the case where the input information is information indicating the no answer. Note that the neural network in or after a second layer of the encoder may be any neural network as long as a latent variable vector Zs is calculated from the intermediate information group {qₛ₁, qₛ₂, . . . q_{SH}}.

### (3: Output Vector)

The output vector in the embodiments of the present invention has the following feature.

[Feature 3] When p(x) is a probability that the input information x is information indicating the positive state, the output vector is a vector having probabilities p(x₁), . . . , p(x_{K}) for K pieces of input information x₁, x_{K} as elements.

Therefore, by using the example of analysis of test results, the decoder uses the latent variable vector Zs as an input, and obtains, as the output vector, a probability vector Pₛ=(Pₛ₁, Pₛ₂, . . . , P_{sK}) having the probability pₛₖ that the s-th learner will correctly answer the k-th question as an element.

### (4: Loss Function)

The loss function in the embodiments of the present invention has the following feature.

[Feature 4] The loss function includes a loss term that does not allow the input information to be a loss, the input information being information indicating the no answer.

Hereinafter, description will be given using the example of analysis of test results. The loss function is set to a loss function including a term L_{RC} regarding a reconstruction error calculated by the following equation representing a sum of losses Lₛₖ for all the questions of all the learners, where the loss Lₛₖ regarding the k-th question of the s-th learner is set as −log (pₛₖ) in the case of x⁽¹⁾ₛₖ=1 (that is, in the case where the test result is the correct answer), set as −log (1−Pₛₖ) in the case of x⁽⁰⁾ₛₖ=1 (that is, in the case where the test result is the wrong answer), and set as 0 in the case of x⁽¹⁾ₛₖ=0 and x⁽⁰⁾ₛₖ=0 (that is, the test result is the no answer)

$$\begin{matrix}[ Math . 2 ] & \\ {L}_{RC} = {\sum }_{s = 1}^{S} {\sum }_{k = 1}^{K} {L}_{sk} & ( 2 )\end{matrix}$$

−log (pₛₖ) has a larger value as the probability pₛₖ that the s-th learner will correctly answer the k-th question is smaller (that is, as the probability is further away from 1) even though the s-th learner has actually given the correct answer to the k-th question. Further, log (1−Pₛₖ) has a larger value as the probability pₛₖ that the s-th learner will correctly answer the k-th question is larger (that is, as the probability is further away from 0) even though the s-th learner has actually given the wrong answer to the k-th question.

### First Embodiment

A neural network learning apparatus 100 learns parameters of a neural network to be learned using learning data. Here, the neural network to be learned includes an encoder that calculates a latent variable vector from an input vector and a decoder that calculates an output vector from the latent variable vector. Furthermore, the parameters of the neural network include a weight parameter and a bias parameter of the encoder, and a weight parameter and a bias parameter of the decoder.

The input information is information indicating one of a positive state, a negative state, or an unknown state, and the input vector is a vector obtained from K pieces (K is an integer of 2 or more) of input information x₁, . . . and x_{K} by expressing the input information by using two bits of a positive information bit set to 1 when the input information is information indicating the positive state, or set to 0 when the input information is information indicating the unknown state or information indicating the negative state, and a negative information bit set to 1 when the input information is information indicating the negative state, or set to 0 when the input information is information indicating the unknown state or information indicating the positive state. Therefore, the input vector is a vector with an element of 0 or 1. Further, p(x) is a probability that input information x is information indicating the positive state, and the output vector is a vector having probabilities p(x₁), . . . , p(x_{K}) for the K pieces of input information x₁, . . . , x_{K} as elements. The latent variable vector is a vector having the latent variable as an element.

Note that, as described in <Technical Background>, a first layer of the encoder obtains a vector having H pieces of intermediate information qₛ₁, . . . , q_{sH} as elements from the input vector, setting x⁽¹⁾ₛₖ and x⁽⁰⁾ₛₖ as the positive information bit and the negative information bit with respect to the input information x_{K} of s-th learning data, respectively, and the intermediate information qₛₕ is a value obtained by further adding a value of the bias parameter to a value obtained by adding all of values obtained by multiplying each of the values of the positive information bits by the weight parameter and values obtained by multiplying each of the values of the negative information bits by the weight parameter, as expressed by the equation (1).

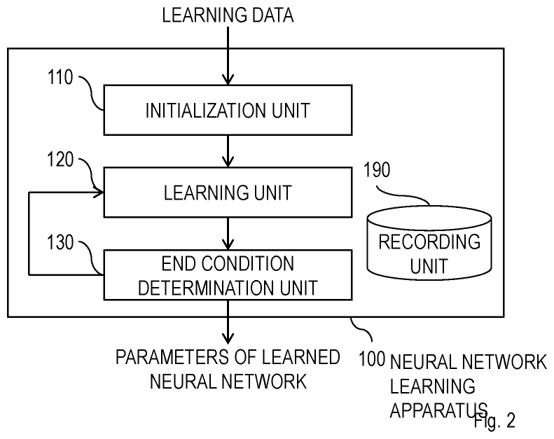

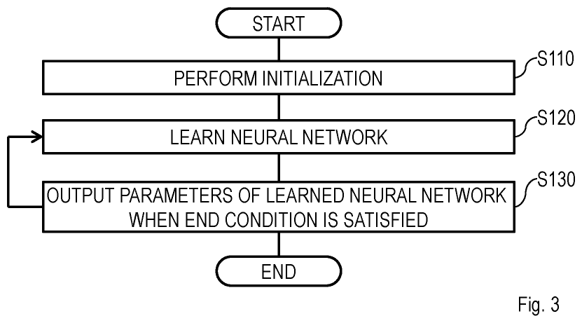

Hereinafter, the neural network learning apparatus 100 will be described with reference to FIGS. 2 and 3. FIG. 2 is a block diagram illustrating a configuration of the neural network learning apparatus 100. FIG. 3 is a flowchart illustrating an operation of the neural network learning apparatus 100. As illustrated in FIG. 2, the neural network learning apparatus 100 includes an initialization unit 110, a learning unit 120, an end condition determination unit 130, and a recording unit 190.

The recording unit 190 is a configuration unit that appropriately records information necessary for processing of the neural network learning apparatus 100. The recording unit 190 records, for example, initialization data used for initialization of the neural network. Here, the initialization data is initial values of the parameters of the neural network, and is, for example, initial values of the weight parameter and the bias parameter of the encoder, and initial values of the weight parameters and the bias parameters of the decoder. Furthermore, the recording unit 190 may record the learning data in advance. Note that, since the learning data is an input to the encoder, the learning data is given as an input vector. In an example of analysis of test results, the learning data is the test results of a plurality of questions for a plurality of learners.

The operation of the neural network learning apparatus 100 will be described with reference to FIG. 3.

In S110, the initialization unit 110 performs initialization processing of the neural network using the initialization data. Specifically, the initialization unit 110 sets the initial value for each parameter of the neural network.

In S120, the learning unit 120 uses the learning data as an input, performs processing of updating each parameter of the neural network by using the learning data (hereinafter referred to as parameter update processing), and outputs the parameters of the neural network together with information (for example, the number of times the parameter update processing has been performed) necessary for the end condition determination unit 130 to determine an end condition. The learning unit 120 learns the neural network by, for example, a back propagation method using a loss function. That is, in each parameter update processing, the learning unit 120 performs processing of updating each parameter of the encoder and the decoder so that the loss function becomes small.

The loss function includes a term L_{RC} regarding a reconstruction error of the equation (2). That is, the loss function includes a loss term that is larger as the probability p(x) for the input information x is smaller in the case where the input information x is information indicating the positive state, is larger as the probability p(x) for the input information x is larger in the case where the input information x is information indicating the negative state, and is substantially 0 in the case where the input information x is information indicating the unknown state.

In S130, the end condition determination unit 130 uses the parameters of the neural network output in S120 and the information necessary for determining the end condition output in S120 as inputs, and determines whether the end condition that is a condition regarding the end of learning is satisfied (for example, the number of times the parameter update processing has been performed has reached a predetermined number of times of repetition). In a case where the end condition is satisfied, the end condition determination unit 130 outputs the parameters of the neural network obtained in S120 that has been performed last as the parameters of the learned neural network and terminates the processing, while in a case where the end condition is not satisfied, the processing returns to the processing in S120.

According to the embodiment of the present invention, it is possible to learn a neural network including an encoder and a decoder, which can estimate a state of input information indicating an unknown state as a probability for the input information. As a result, for example, it is possible to learn a neural network that predicts a probability that a learner will correctly answer a question that the learner has not taken.

### Second Embodiment

In the present embodiment, a state estimation apparatus that estimates a state of input information indicating an unknown state using a learned neural network learned using the first embodiment will be described. Here, setting input information as information indicating one of a positive state, a negative state, or an unknown state, setting an input vector as a vector obtained from K pieces (K is an integer of 2 or more) of input information x₁, . . . , x_{K} by expressing the input information using two bits of a positive information bit set to 1 when the input information is information indicating the positive state, or set to 0 when the input information is information indicating the unknown state or information indicating the negative state, and a negative information bit set to 1 when the input information is information indicating the negative state, or set to 0 when the input information is information indicating the unknown state or information indicating the positive state, setting p(x) as a probability that input information x is information indicating the positive state, setting an output vector as a vector having probabilities p(x₁), . . . , p(x_{K}) for the K pieces of input information x₁, . . . , x_{K} as elements, the learned neural network is a neural network including an encoder that calculates a latent variable vector having a latent variable as an element from the input vector and a decoder that calculates an output vector from the latent variable vector and having performed learning by repeating parameter update processing of updating parameters of the encoder and the decoder by using a loss function including a loss term that is larger as the probability p(x) for the input information x is smaller in a case where the input information x is information indicating a positive state, is larger as the probability p(x) for the input information x is larger in a case where the input information x is information indicating a negative state, and is substantially 0 in a case where the input information x is information indicating an unknown state.

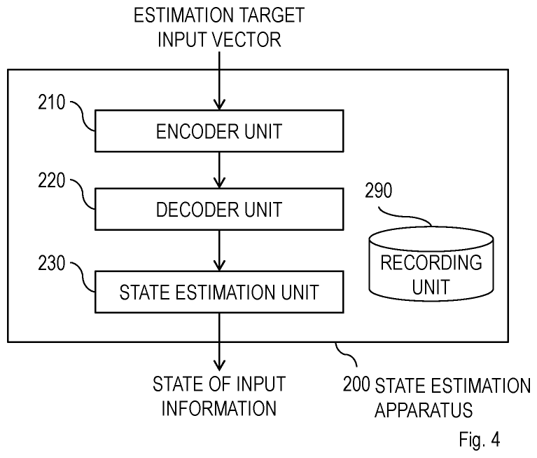

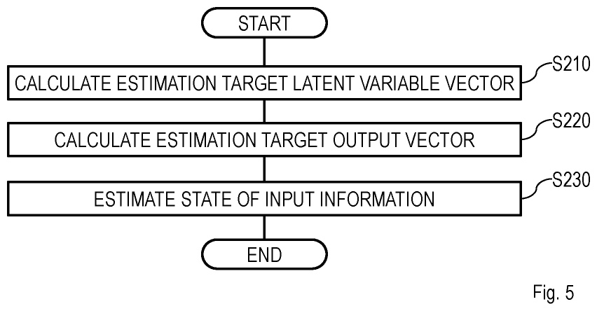

Hereinafter, a state estimation apparatus 200 will be described with reference to FIGS. 4 and 5. FIG. 4 is a block diagram illustrating a configuration of the state estimation apparatus 200. FIG. 5 is a flowchart illustrating an operation of the state estimation apparatus 200. As illustrated in FIG. 4, the state estimation apparatus 200 includes an encoder unit 210, a decoder unit 220, a state estimation unit 230, and a recording unit 290.

The recording unit 290 is a configuration unit that appropriately records information necessary for processing of the state estimation apparatus 200. The recording unit 290 records the parameters of the learned neural network, for example.

The operation of the state estimation apparatus 200 will be described with reference to FIG. 5.

In S210, the encoder unit 210 uses an estimation target input vector obtained from the K pieces of input information x₁, . . . and x_{K} as an input, calculates an estimation target latent variable vector from the estimation target input vector using the encoder of the learned neural network, and outputs the estimation target latent variable vector.

In S220, the decoder unit 220 uses the estimation target latent variable vector calculated in S210 as an input, calculates an estimation target output vector from the estimation target latent variable vector using a decoder of the learned neural network, and outputs the estimation target output vector.

In S230, the state estimation unit 230 uses the estimation target output vector calculated in S220 as input, obtains a probability p(xₖ) corresponding to the input information x_{K} (here, k satisfies 1≤k≤K) indicating the unknown state from the estimation target output vector, and outputs the probability p(xₖ) as an estimated probability that the input information x_{K} is in the positive state.

According to the embodiment of the present invention, it is possible to estimate a state of input information indicating an unknown state as a probability for the input information. As a result, for example, it is possible to predict a probability that a learner will correctly answer a question that the learner has not taken among a plurality of questions from test results of questions that the estimation target learner has taken among the plurality of questions.

### Third Embodiment

There may be a case where analysis of test results of an estimation target learner has been completed, and a latent variable vector indicating ability of the learner has already been obtained. Therefore, in the present embodiment, a state estimation apparatus that estimates a state of input information indicating an unknown state using a latent variable vector as an input will be described. That is, the present embodiment is different from the first embodiment in that a vector serving as an input is different.

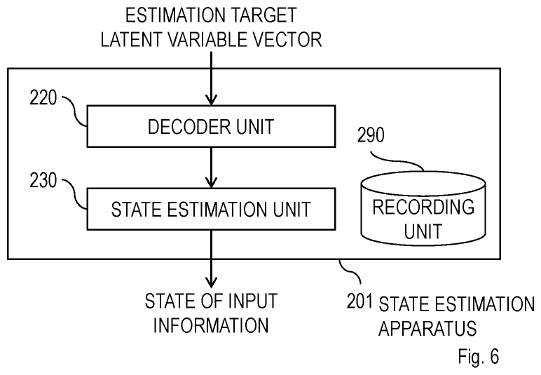

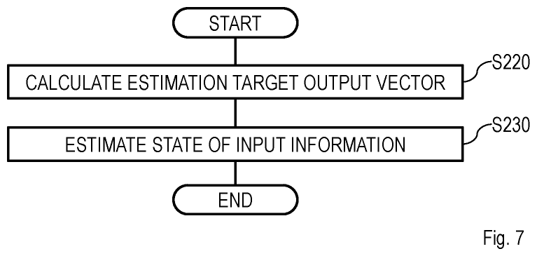

Hereinafter, a state estimation apparatus 201 will be described with reference to FIGS. 6 and 7. FIG. 6 is a block diagram illustrating a configuration of the state estimation apparatus 201. FIG. 7 is a flowchart illustrating an operation of the state estimation apparatus 201. As illustrated in FIG. 6, the state estimation apparatus 201 includes a decoder unit 220, a state estimation unit 230, and a recording unit 290. The recording unit 290 is a configuration unit that appropriately records information necessary for processing of the state estimation apparatus 201. The recording unit 290 records parameters of a decoder of a learned neural network, for example.

The operation of the state estimation apparatus 201 will be described with reference to FIG. 7.

In S220, the decoder unit 220 uses an estimation target latent variable vector calculated, using an encoder of the learned neural network, from an estimation target input vector obtained from K pieces of input information x₁, . . . , x_{K} as an input, and calculates an estimation target output vector from the estimation target latent variable vector using a decoder of the learned neural network and outputs the estimation target output vector.

In S230, the state estimation unit 230 uses the estimation target output vector calculated in S220 as input, obtains a probability p(xₖ) corresponding to the input information x_{K} (here, k satisfies 1≤k≤K) indicating the unknown state from the estimation target output vector, and outputs the probability p(xₖ) as an estimated probability that the input information x_{K} is in the positive state.

According to the embodiment of the present invention, it is possible to estimate a state of input information indicating an unknown state as a probability for the input information. As a result, for example, it is possible to predict a probability that a learner will correctly answer a question that the learner has not taken among a plurality of questions from the latent variable vector of the estimation target learner obtained from test results of questions that the estimation target learner has taken among the plurality of questions.

### Fourth Embodiment

In the present embodiment, a question recommendation apparatus that recommends a question to be solved by a recommendation target learner, using a state estimation apparatus 200 or 201 will be described. Here, K pieces of input information in the state estimation apparatus 200 or 201 are set as test results of K questions, and a positive state, a negative state, and an unknown state are set as a correct answer, a wrong answer, and no answer, respectively.

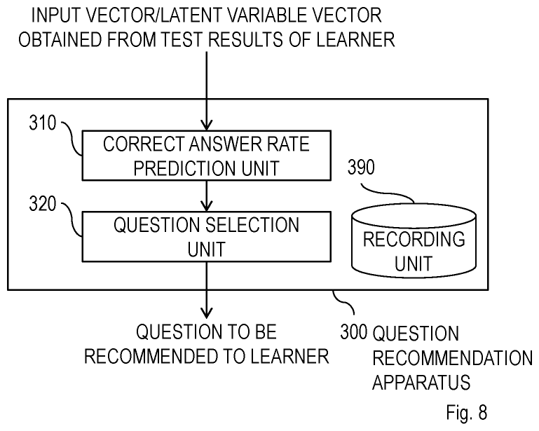

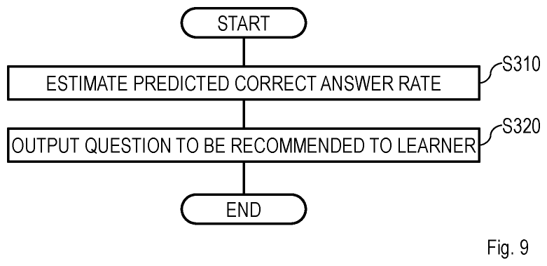

Hereinafter, a question recommendation apparatus 300 will be described with reference to FIGS. 8 and 9. FIG. 8 is a block diagram illustrating a configuration of the question recommendation apparatus 300. FIG. 9 is a flowchart illustrating an operation of the question recommendation apparatus 300. As illustrated in FIG. 8, the question recommendation apparatus 300 includes a correct answer rate prediction unit 310, a question selection unit 320, and a recording unit 390. The recording unit 390 is a configuration unit that appropriately records information necessary for processing by the question recommendation apparatus 300.

The operation of the question recommendation apparatus 300 will be described with reference to FIG. 9.

In S310, the correct answer rate prediction unit 310 uses an input vector obtained from test results x_{K} (k=1, . . . , K) of a recommendation target learner for the K questions as an input, calculates an output vector (hereinafter referred to as a predicted correct answer rate vector) from the input vector using a learned neural network, selects a probability corresponding to the input information indicating no answer from elements p(x_{K}) (k=1, . . . , K) of the predicted correct answer rate vector, and outputs the probability as the predicted correct answer rate of the learner for a question that has not taken by the learner. The correct answer rate prediction unit 310 can be configured using, for example, the state estimation apparatus 200. Note that an example of configuring the correct answer rate prediction unit 310 using the state estimation apparatus 201 will be described below.

In S320, the question selection unit 320 uses, as inputs, predicted correct answer rates p_{i_1}, . . . . P_{i_M} of the recommendation target learner of questions i₁, . . . i_{M} (where M is an integer of 1 or more and K or less, iₘ (m=1, . . . , M) satisfies 1≤iₘ≤K, and iₘ and i_{m′} (m≠m′) are different from each other) that have not been taken by the learner and a predicted correct answer rate (hereinafter referred as a reference predicted correct answer rate) to be a reference for recommending a question to be solved, and selects and outputs questions i_{m_1}, . . . , i_{m_N} to be recommended to the recommendation target learner from among the questions i₁, . . . , i_{M}, using the reference predicted correct answer rate and the predicted correct answer rates p_{i_1}, P_{i_M} of the recommendation target learner of the questions i₁, . . . , i_{M} that have not been taken by the learner. The reference predicted correct answer rate can be, for example, 0.5. Note that this example is based on an idea that a question in which the predicted correct answer rate of the recommendation target learner is close to 0 is too difficult for the learner, a question in which the predicted correct answer rate of the learner is close to 1 is too easy for the learner, and a question in which the predicted correct answer rate of the learner is close to 0.5 will be lead to improvement of academic ability of the learner if the learner makes an effort to solve the question.

For example, the question selection unit 320 may select questions in which the predicted correct answer rate P_{i_m} (m=1, . . . , M) of the recommendation target learner is included in a predetermined range including the reference predicted correct answer rate from the questions i₁, . . . , i_{M} that have not been taken by the learner as the questions i_{m_1}, . . . , i_{m_N} to be recommended to the learner. The predetermined range including the reference predicted correct answer rate can be, for example, a range from 0.4 to 0.6 where the reference predicted correct answer rate is 0.5.

Further, the question selection unit 320 may preferentially select questions in which the predicted correct answer rates p_{i_m} (m=1, . . . , M) of the recommendation target learner are close to the reference predicted correct answer rate from the questions i₁, . . . , i_{M} that have not been taken by the learner as the questions i_{m_1}, . . . , i_{m_N} to be recommended to the learner. Specifically, the question selection unit 320 is only required to select N questions in order from a question with a smallest absolute value of a difference between the predicted correct answer rate p_{i_m} (m=1, . . . , M) of the recommendation target learner and the reference predicted correct answer rate from the questions i₁, . . . , i_{M} that have not been taken by the learner.

Note that the reference predicted correct answer rate, the predetermined range including the reference predicted correct answer rate, and the number N of questions to be selected may be recorded in advance by the recording unit 390, or may be received by an input unit (not illustrated) as a desired input value by a user of the question recommendation apparatus 300.

Further, for example, a question that has been taken by the recommendation target learner but a considerable time has elapsed since an examination may be included as the selection candidate for the questions to be recommended. In other words, the question selection unit 320 may include not only the question that has not been taken by the recommendation target learner but also one or more questions that have been taken by the learner in the questions i₁, . . . , i_{M} of the selection candidates for the questions to be recommended, and for this purpose, the correct answer rate prediction unit 310 may select the probability corresponding to the questions i₁, . . . , i_{M} of the selection candidates for the questions to be recommended from the elements p(Xₖ) (k=1, . . . , K) of the predicted correct answer rate vector of the learner. For example, if all of questions are to be included in the selection candidates for the questions to be recommended regardless of whether or not those have already been taken by the recommendation target learner, the correct answer rate prediction unit 310 is only required to output all the elements p(X_{K}) (k=1, . . . , K) of the predicted correct answer rate vector. In this case, in S310, the correct answer rate prediction unit 310 uses the input vector obtained from the test results X_{K} (k=1, . . . , K) of the recommendation target learner for the K questions as an input, calculates the output vector (predicted correct answer rate vector) from the input vector using the learned neural network, selects a probability corresponding to the questions of the selection candidates for the questions to be recommended to the learner from the elements p(Xₖ) (k=1, . . . , K) of the predicted correct answer rate vector, and outputs the probability as the predicted correct answer rate of the learner of the questions of the selection candidates for the questions to be recommended to the learner. Further, in S320, the question selection unit 320 uses, as inputs, the predicted correct answer rates P_{i_1}/P_{i_M} of the recommendation target learner of the questions i₁, . . . , i_{M} (where M is an integer of 1 or more and K or less, iₘ (m=1, . . . , M) satisfies 1≤iₘ≤K, and iₘ and i_{m′} (m≠m′) are different from each other) of the selection candidates for the questions to be recommended to the learner of the K questions and the predicted correct answer rate (reference predicted correct answer rate) to be a reference for recommending a question to be solved, and selects and outputs the questions i_{m_1}, . . . , i_{m_N} to be recommended to the recommendation target learner from among the questions i₁, . . . i_{M}, using the reference predicted correct answer rate and the predicted correct answer rates P_{i_1}, . . . , P_{i_M} of the recommendation target learner of the questions i₁, . . . , i_{M} of the selection candidates for the questions to be recommended to the learner of the K questions. Then, for example, the question selection unit 320 may select questions in which the predicted correct answer rates p_{i_m} (m=1, . . . , M) is included within a predetermined range including the reference predicted correct answer rate as the questions i_{m_1}, . . . , i_{m_N} to be recommended to the learner from among the questions i₁, . . . , i_{M} of the selection candidates for the questions to be recommended to the learner among the K questions, or the question selection unit 320 may preferentially select questions in which the predicted correct answer rates p_{i_m} (m=1, . . . , M) are close to the reference predicted correct answer rate as the questions i_{m_1}, . . . , i_{m_N} to be recommended to the learner from among the questions 1, . . . , iₘ of the selection candidates for the questions to be recommended to the learner among the K questions.

Furthermore, for example, an input vector setting the test result to be no answer for a question that the recommendation target learner has actually given the correct answer may be used, or an input vector setting the test result to be no answer for a question that the recommendation target learner has actually given the wrong answer may be used. Specifically, an input vector setting the test results of a predetermined number of questions to be no answer in order from a question with a maximum difference may be used, the difference being a difference between the predicted correct answer rate and a value indicating actual correct/wrong among the questions that the recommendation target learner has given the correct answer and the questions that the learner has given the wrong answer, or an input vector setting the test results for questions having the difference equal to or larger than a predetermined threshold to be no answer may be used. The input vector can be generated by an operation similar to the question recommendation apparatus 300. That is, it is only required to obtain the predicted correct answer rates of the questions that the recommendation target learner has given correct answer and the questions that the learner has given wrong answer from the vector representing the actual test results of the learner by an operation similar to the correct answer rate prediction unit 310 of the question recommendation apparatus 300, calculate the difference of 1 from the predicted correct answer rate for the questions with the correct answer and the difference of 0 from the predicted correct answer rate for the questions with the wrong answer by an operation similar to the question selection unit 320 of the question recommendation apparatus 300, select a predetermined number of questions in order from the question with the maximum difference obtained by the calculation, and generate the input vector setting the test results to be no answer for the selected questions, or select a question with the difference obtained by the calculation that is larger than or equal to or larger than a predetermined threshold, and generate the input vector setting the test result to be no answer for the selected question. In this way, it is possible to leave a possibility that even a question that the recommendation target learner has accidentally given the correct answer or a question that the learner has accidentally given the wrong answer is selected as the question to be recommended. Similarly, an input vector setting the test result to be no answer for a question for which a considerable time has elapsed since the recommendation target learner actually took an examination may be used. In this way, it is possible to recommend the questions to be solved in a form of prompting the recommendation target learner to learn again.

### (Modification)

The correct answer rate prediction unit 310 may be configured using the state estimation apparatus 201 instead of the state estimation apparatus 200. In this case, the correct answer rate prediction unit 310 uses a latent variable vector calculated, using an encoder of a learned neural network, from an input vector obtained from test results x_{K} (k=1, . . . , K) of a recommendation target learner for the K questions as an input, calculates an output vector (predicted correct answer rate vector) from the latent variable vector using a decoder of the learned neural network, selects a probability corresponding to the input information indicating no answer from elements p(Xₖ) (k=1, . . . , K) of the predicted correct answer rate vector, and outputs the probability as the predicted correct answer rate of the learner for a question that has not taken by the learner. Alternatively, the correct answer rate prediction unit 310 uses the latent variable vector calculated, using the encoder of the learned neural network, from the input vector obtained from the test results X_{K} (k=1, . . . , K) of the recommendation target learner for the K questions as an input, calculates the output vector (predicted correct answer rate vector) from the latent variable vector using the decoder of the learned neural network, selects a probability corresponding to the questions of the selection candidates for the questions to be recommended to the learned from the elements p(Xₖ) (k=1, . . . , K) of the predicted correct answer rate vector, and 1, . . . outputs the probability as the predicted correct answer rate of the learner of the questions of the selection candidates for the questions to be recommended to the learner.

According to the embodiment of the present invention, it is possible to recommend a question suitable for use in future study as a question to be solved to the recommendation target learner.

### <Supplementary Note>

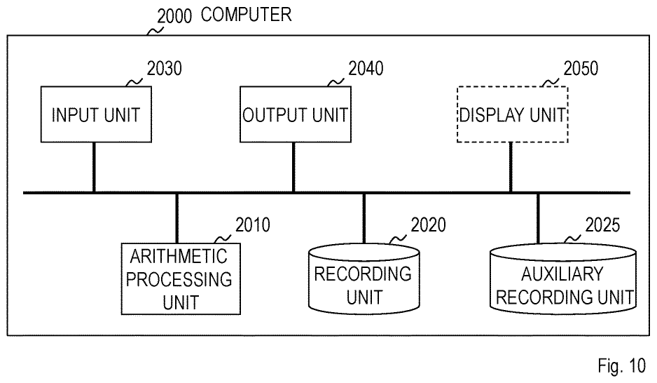

Processing of each unit of each device described above may be implemented by a computer, and in this case, processing contents of a function that each device should have are written by a program. Then, by causing a recording unit 2020 of a computer 2000 illustrated in FIG. 10 to read this program and causing an arithmetic processing unit 2010, an input unit 2030, an output unit 2040, an auxiliary recording unit 2025, and the like to operate, processing functions in each device described above are implemented on the computer.

The device of the present invention includes, for example, as a single hardware entity, an input unit to which a signal can be input from the outside of the hardware entity, an output unit through which a signal can be output to the outside of the hardware entity, a communication unit to which a communication device (for example, a communication cable) capable of communicating with the outside of the hardware entity can be connected, a CPU (Central Processing Unit, which may include a cache memory, a register, and the like) which is an arithmetic processing unit, a RAM and a ROM which are memories, an external storage device which is a hard disk, and a bus connected such that the input unit, the output unit, the communication unit, the CPU, the RAM, the ROM, and the external storage device can exchange data. A device (drive) or the like that can write and read data in and from a recording medium such as a CD-ROM may be provided in the hardware entity as necessary. Examples of a physical entity including such a hardware resource include a general-purpose computer and the like.

The external storage device of the hardware entity stores a program required to implement the above-described functions, data required to process the program, and the like (the present invention is not limited to the external storage device and the program may be stored, for example, in a ROM, which is a read-only storage device). Data or the like obtained by processing the program is appropriately stored in a RAM, an external storage device, or the like.

In the hardware entity, each program stored in the external storage device (or the ROM or the like) and data required for processing by each program are read into a memory as necessary and are appropriately interpreted, executed, and processed by the CPU. As a result, the CPU implements predetermined functions (each of the constituent units represented as . . . unit, . . . means, etc.). That is, each of the constituent units of the embodiments of the present invention may include processing circuitry.

As described above, when the processing function of the hardware entity (the device according to the present invention) described in the foregoing embodiment is implemented by a computer, processing content of the function of the hardware entity is described by a program. In addition, as the computer executes the program, the processing function of the hardware entity is implemented on the computer.

The program in which the processing content is written may be recorded on a computer-readable recording medium. The computer-readable recording medium is, for example, a non-transitory recording medium and is specifically a magnetic recording device, an optical disc, or the like.

In addition, the program is distributed by, for example, selling, transferring, or renting a portable recording medium such as a DVD or a CD-ROM on which the program is recorded. Further, the program may be stored in a storage device of a server computer, and the program may be distributed by transferring the program from the server computer to another computer via a network.

For example, the computer that executes such a program first temporarily saves the program recorded in the portable recording medium or the program transferred from the server computer in the auxiliary recording unit 2025 as the own non-transitory storage device of the computer. Then, at the time of executing processing, this computer reads the program saved in the auxiliary recording unit 2025 as the own non-transitory storage device of the computer into the recording unit 2020 and executes processing in accordance with the read program. As another mode of executing this program, the computer may directly read the program from the portable recording medium into the recording unit 2020 and execute processing in accordance with the read program, or alternatively, each time the program is transferred to this computer from the server computer, the computer may sequentially execute processing in accordance with the received program. Moreover, the above-described processing may be executed by a so-called ASP (Application Service Provider) type service that implements a processing function only by an execution instruction and result acquisition without transferring the program from a server computer to the computer. Note that the program in the present form includes information that is used for processing by an electronic computer and is equivalent to the program (data or the like that is not a direct command to the computer but has property that defines processing performed by the computer).

In addition, although the present devices are each configured by executing a predetermined program on a computer in this form, at least a part of the processing content may be implemented by hardware.

The present invention is not limited to the above-described embodiments and can be appropriately modified without departing from the gist of the present invention.

1-2. (canceled)

3. A question recommendation apparatus comprising:
setting input information as information indicating one of a positive state, a negative state, or an unknown state,
setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state,
setting p(x) as a probability that the input information x is information indicating the positive state,
setting an output vector as a vector having probabilities p(x₁), . . . , p(x_{K}) for the K pieces of input information x₁, . . . , x_{K} as elements,
a processing circuitry configured to record a parameter of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state;
setting the K pieces of input information as test results of K questions, and setting the positive state, the negative state, and the unknown state as a correct answer, a wrong answer, and no answer, respectively,
calculate an output vector from an input vector obtained from test results xₖ (k=1, . . . , K) of a learner of the K questions by using the learned neural network, select a probability corresponding to a question of a selection candidate for a question to be recommended to the learner from elements p(Xₖ) (k=1, . . . , K) of the output vector, and obtain the probability as a predicted correct answer rate of the question of the selection candidate for the question to be recommended to the learner; and
setting p_{i_1}, . . . , p_{i_M} (where M is an integer of 1 or more and K or less, iₘ (m=1, . . . , M) satisfies 1≤iₘ≤K, and iₘ and i_{m′} (m≠m′) are different from each other) as predicted correct answer rates of the questions i₁, . . . , i_{M} that are the selection candidates for the question to be recommended to the learner among the K questions, and setting a reference predicted correct answer rate as a predicted correct answer rate that is reference for recommending a question to be solved,
select questions i_{m_1}, . . . , i_{m_N} to be recommended to the learner from among the questions i₁, . . . , i_{M} by using the reference predicted correct answer rate and the predicted correct answer rates p_{i_1}, . . . , p_{i_M} of the questions i₁, . . . , i_{M} that are the selection candidates for the question to be recommended to the learner among the K questions.

4. A question recommendation apparatus comprising:
setting input information as information indicating one of a positive state, a negative state, or an unknown state,
setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state,
setting p(x) as a probability that the input information x is information indicating the positive state,
setting an output vector as a vector having probabilities p(x₁), . . . , p(x_{K}) for the K pieces of input information x₁, . . . , x_{K} as elements,
a processing circuitry configured to record a parameter of a decoder of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state;
setting the K pieces of input information as test results of K questions, and setting the positive state, the negative state, and the unknown state as a correct answer, a wrong answer, and no answer, respectively,
calculate an output vector from a latent variable vector corresponding to an input vector obtained from test results Xₖ (k=1, . . . , K) of a learner of the K questions by using the decoder of the learned neural network, select a probability corresponding to a question of a selection candidate for a question to be recommended to the learner from elements p(Xₖ) (k=1, . . . , K) of the output vector, and obtain the probability as a predicted correct answer rate of the question of the selection candidate for the question to be recommended to the learner; and
setting p_{i_1}, . . . , p_{i_M} (where M is an integer of 1 or more and K or less, iₘ (m=1, . . . , M) satisfies 1≤iₘ≤K, and iₘ and i_{m′} (m≠m′) are different from each other) as predicted correct answer rates of the questions i₁, . . . , i_{M} that are the selection candidates for the question to be recommended to the learner among the K questions, and setting a reference predicted correct answer rate as a predicted correct answer rate that is reference for recommending a question to be solved,
select questions i_{m_1}, . . . , i_{m_N} to be recommended to the learner from among the questions i₁, . . . , i_{M} by using the reference predicted correct answer rate and the predicted correct answer rates p_{i_1}, . . . , p_{i_M} of the questions i₁, . . . , i_{M} that are the selection candidates for the question to be recommended to the learner among the K questions.

5. The question recommendation apparatus according to claim 3, wherein
the questions i_{m_1}, . . . , i_{m_N} to be recommended to the learner include only questions that have not taken by the learner.

6. The question recommendation apparatus according to claim 3, wherein
the processing circuitry selects questions in which the predicted correct answer rates p_{i_m} (m=1, . . . , M) are included in a predetermined range including the reference predicted correct answer rate as the questions i_{m_1}, . . . , i_{m_N} to be recommended to the learner from among the questions i₁, . . . , i_{M} of the selection candidates for the question to be recommended to the learner among the K questions.

7. The question recommendation apparatus according to claim 3, wherein
the processing circuitry preferentially selects questions in which the predicted correct answer rates p_{i_m} (m=1, . . . , M) are close to the reference predicted correct answer rate as the questions i_{m_1}, . . . , i_{m_N} to be recommended to the learner from among the questions i₁, . . . , i_{M} of the selection candidates for the question to be recommended to the learner among the K questions.

8-11. (canceled)

12. A non-transitory computer-readable storage medium which stores a program for causing a computer to function as the question recommendation apparatus according to claim 3.

13. The question recommendation apparatus according to claim 4, wherein
the questions i_{m_1}, . . . , i_{m_N} to be recommended to the learner include only questions that have not taken by the learner.

14. The question recommendation apparatus according to claim 4, wherein
the processing circuitry selects questions in which the predicted correct answer rates p_{i_m} (m=1, . . . , M) are included in a predetermined range including the reference predicted correct answer rate as the questions i_{m_1}, . . . , i_{m_N} to be recommended to the learner from among the questions i₁, . . . , i_{M} of the selection candidates for the question to be recommended to the learner among the K questions.

15. The question recommendation apparatus according to claim 4, wherein
the processing circuitry preferentially selects questions in which the predicted correct answer rates p_{i_m} (m=1, . . . , M) are close to the reference predicted correct answer rate as the questions i_{n_1}, . . . , i_{m_N} to be recommended to the learner from among the questions i₁, . . . , i_{M} of the selection candidates for the question to be recommended to the learner among the K questions.

16. A non-transitory computer-readable storage medium which stores a program for causing a computer to function as the question recommendation apparatus according to claim 4.
